(19) United States
(12) Patent Application Publication
(10) Pub. No.: US 2009/0327756 A1
(43) Pub. Date: Dec. 31, 2009

(54) SECURE DIGITAL CONTENT STORAGE DEVICE

(76) Inventor: Stuart Pekowsky, Naila (DE)

Correspondence Address: AMSTER, ROTHSTEIN & EBENSTEIN LLP, 90 PARK AVENUE, NEW YORK, NY, 10016, US

(21) Appl. No.: 12/122,466

(22) Filed: May 16, 2008

(51) Int. Cl. G06F 12/14

(52) U.S. Cl. 713/192; 713/193; 713/194; 713/189

(57) ABSTRACT

A secure digital content storage device comprising a memory for storing digital data, a decoder, coupled to the memory, for generating analog output based on the digital data, and a secure enclosure, or a secure connection between the memory and the decoder, or a single monolithic integrated circuit structure for preventing unauthorized access to the digital content stored in the memory. Under the present invention, the secure digital content storage device protects the digital content stored therein from unauthorized replication or tampering by an external device or agent.

### FIELD OF INVENTION

The present invention relates to a device for storing digital data and providing access to only an analog version thereof. More particularly, the present invention relates to systems and methods for protecting stored digital data from unauthorized access or use by only providing an analog version as output.

### BACKGROUND OF THE INVENTION

With the rapid development of information technology, the digitization of information has greatly increased in recent years. The benefits of digitizing information are many. Digitized information (hereinafter, “digital content”) is easier to process and transmit than its analog counterpart. In addition, the quality of the digital content does not deteriorate with time or by copying. Accordingly, more and more text, audio, image and video data are becoming digitized and stored in various media in digital form (e.g., e-books, music recordings in MP3 format, digital photos, movies recorded on Blu-ray discs, etc.).

When audio/video data was mostly distributed in analog format (e.g., in the form of LPs, cassette tapes, analog VHS), unauthorized replication was less of a concern, because analog signals are difficult to replicate exactly without degradation and their replication and distribution usually involve cumbersome processes. On the other hand, unlike its analog counterpart, a digital copy is exactly identical to, and therefore indistinguishable from, the original digital content. That fact, combined with the ease with which digital content can be copied and distributed, has often led to unauthorized replication and distribution of copyrighted digital content. The problem of such unauthorized replication is widespread, causing substantial loss of potential royalty income for the digital content creators and copyright owners. Accordingly, protection of digital content from unauthorized access and replication has become an important concern in this information age.

FIG. 1 shows how the digital content stored in a conventional arrangement can become vulnerable to unauthorized external access and tampering. In FIG. 1, digital content stored in an external content source 101 is accessed by a player device 103 via a digital data bus 102. The digital content stored in an external content source 101 may but does not have to be encrypted. If encrypted, the digital content is decrypted by an optional decrypter 104 in the player device 103. The decrypted digital content is then transferred to a decoder 106 of the player device 103 via an unencrypted digital data bus 105. Based on the received digital content, the decoder 106 generates a corresponding analog output 107 for, for example, a video or audio device.

Because the external content source 101 for storing digital content and the decoder 106 for generating the corresponding analog output 107 are coupled by an easily accessible digital data bus 102 carrying the original digital data, such digital data is exposed to the risk of external tampering. In particular, the digital content stored in the content source 101 is vulnerable to unauthorized and undesirable replication.

There exist various sophisticated encryption and other digital rights management technologies, usually in the form of software, that may be implemented to strengthen the security of digital content against such external tampering and unauthorized replication. However, their use often adds an undesirable layer of complexity to the digital content management, and also increases the cost of storing and maintaining the digital content by way of expenses for using, developing, maintaining, and/or updating such sophisticated technology. In addition, even sophisticated encryption and digital rights management technologies often become vulnerable to determined hackers or interlopers.

Hence, there is a need and desire in the industry to find a simpler alternative technique for protecting digital content from unauthorized use and replication. Furthermore, there is a need and desire for a direct approach that can make external access to digital content extremely difficult and virtually physically impossible for even the most determined hacker.

It is an object of the present invention to protect digital content stored in a memory from unauthorized access or replication.

It is another object of the present invention to restrict physical access to the digital content stored in a memory.

It is another object of the present invention to protect against unauthorized replication of digital content by appropriately coupling the memory for storing digital content with an applicable decoder in such a way to physically prevent unauthorized external access to the digital content.

Other objects and advantages of the present invention will become apparent from the following description.

### BRIEF DESCRIPTION OF THE DRAWINGS

The above and related objects, features and advantages of the present invention will be more fully understood by reference to the following, detailed description of the preferred, albeit illustrative, embodiments of the present invention when taken in conjunction with the accompanying figures, wherein:

FIG. 1 schematically illustrates a conventional coupling between a digital content source and a player device, as used in the prior art.

FIG. 2 schematically illustrates one exemplary embodiment of the present invention based on a single monolithic integrated circuit structure.

FIGS. 3A and 3B schematically illustrate other exemplary embodiments of the present invention based on a secure coupling or connection between a memory and a decoder.

FIG. 4 schematically illustrates yet another exemplary embodiment of the present invention based on a secure enclosure for a memory and a decoder.

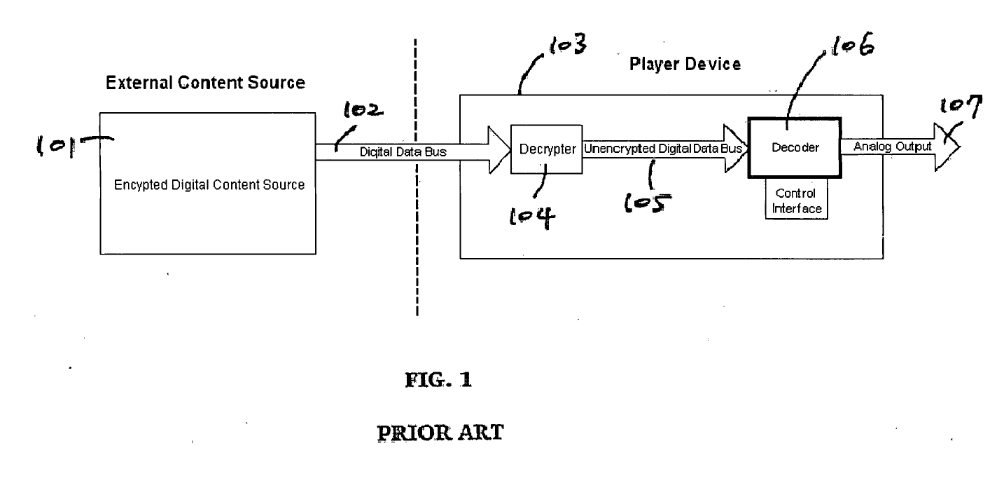

### SUMMARY OF THE INVENTION

It has now been found that the above and related objects of the present invention are obtained in the form of several related aspects, including a secure digital content storage device.

More particularly, the present invention relates to a secure digital content storage device, comprising a memory for storing digital data, and a decoder directly coupled to the memory, for accessing the digital data stored in the memory and generating analog output based on the accessed digital data, wherein the memory and decoder are part of a single integrated circuit so that the digital data stored in the memory cannot be readily accessed.

The secure digital content storage device may further comprise a control circuit for controlling the processing of the digital data within the integrated circuit.

The secure digital content storage device may further comprise an analog-to-digital converter for re-digitizing the analog output.

The present invention is also directed to a secure digital content storage device, comprising a memory for storing digital data, a decoder for accessing the digital data stored in the memory and generating analog output based on the accessed digital data, and a secure connection for coupling the memory to the decoder so that the digital data stored in the memory cannot be readily accessed.

The memory and the decoder in the secure digital content storage device may be located in different integrated circuit dies.

The secure connection between the memory and the decoder in the different integrated circuit dies may comprise wiring encapsulated in a tamper-resistant housing.

Alternatively, the memory and the decoder of the secure digital content storage device may be located in different chip packages on a multilayer PC board. The secure connection between the memory and the decoder in the different chip packages may be formed in an interior layer of the multilayer PC board so that it is inaccessible from outside of the multilayer PC board.

The secure digital content storage device may further comprise a control circuit for controlling the processing of the digital data.

The secure digital content storage device may further comprise an analog-to-digital converter for re-digitizing the analog output.

The present invention is also directed to a secure digital content storage device, comprising a memory for storing digital data, a decoder, coupled to the memory, for accessing the digital data stored in the memory and generating analog output based on the accessed digital data, and a secure enclosure for protecting the memory and decoder from external tampering, so that the digital data stored in the memory cannot be readily accessed.

The secure digital content storage device may further comprise a control circuit for controlling the processing of the digital data within the secure enclosure.

The secure enclosure of the secure digital content storage device may comprise a tamper-proof housing enclosing the memory and decoder.

The memory in the secure digital content storage device may be a storage medium coupled to the decoder via a read/write access, where the storage medium may be DVD, CD-R, magneto-optical disc, floppy disk, memory card, hard disk, or semiconductor memory.

The secure enclosure for the secure digital content storage device may comprise a mechanism for substantially destroying the digital data stored in the memory when the memory becomes exposed to the external tampering.

The secure digital content storage device may further comprise an analog-to-digital converter for re-digitizing the analog output.

The memory and the decoder within the secure enclosure of the secure digital content storage device may be coupled within a single integrated circuit.

Alternatively, the memory and the decoder within the secure enclosure may be located on different integrated circuit dies, and coupled by wiring encapsulated in a tamper-resistant housing.

Alternatively, the memory and the decoder within the secure enclosure may be located in different chip packages on a multilayer PC board, and coupled by a connection formed in an interior layer of the multilayer PC board.

### DETAILED DESCRIPTION OF PREFERRED EMBODIMENTS

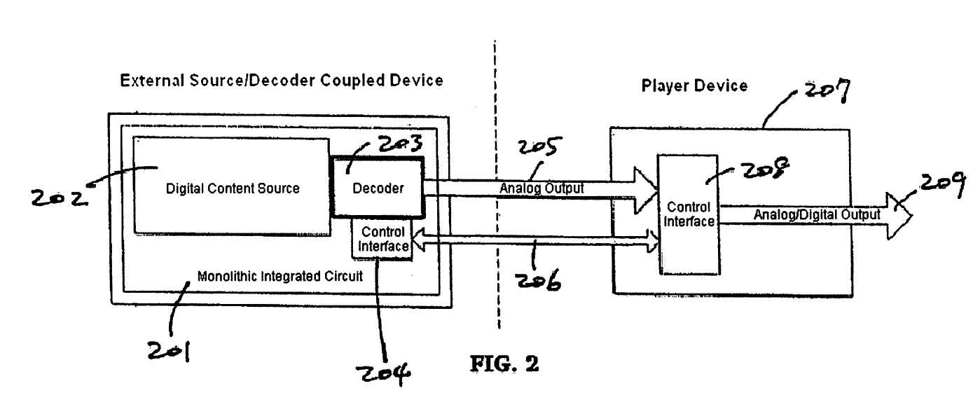

Illustrated in FIG. 2 is a schematic block diagram of an exemplary embodiment of the present invention for a secure digital content storage device 201. The secure digital content storage device 201 is in the form of a single integrated circuit (IC) comprising a memory 202 for storing digital content and a decoder 203. The digital content stored in the memory 202 comprises digital data that needs to be secured against unauthorized replication or tampering (e.g., copyrighted materials), and may include digitized text, audio, image, and/or video data, such as e-books, music recordings in MP3 format, digital photos, movies in MPEG format, etc. The memory 202 may be a large-capacity semiconductor memory, such as a flash memory. With their ever increasing capacity, flash memories are nowadays often used for storing a large amount of audio/video digital data in, for example, MP3/MPEG4 format. The decoder 203 may be an audio/video decoder, and is designed to access the digital content stored in the memory 202, decrypt and/or decode it, and generate the corresponding analog output 205 in a suitable format. The applicable firmware for the decoder 203 may be re-configured by, for example, downloading a new or updated version from the player device, the Internet, an external memory source, or any other suitable source as needed, through use of a control circuit. As shown in FIG. 2, the decoder 203 is directly coupled to the memory 202 within the single monolithic IC structure. In this way, physical access to the digital content stored in the memory 202 by an external device or unauthorized agent can be substantially prevented since sophisticated probes would be required to access the fine line connections that output the digital data from the memory, in view of their extremely small dimensions, typically less than 1 micron (10⁻⁶ m) line width using today's lithography techniques.

FIG. 2 also shows how the secure digital content storage device 201 may interface with an external player device 207 (e.g., audio/video device, PC) without compromising the security of the stored digital content. Significantly, the secure digital content storage device 201 is configured in such a way that its only possible output to the player device 207 or any other external device interfacing with the secure digital content storage device 201 is the corresponding analog output 205 of the digital content stored in the memory 202. The external player device 207 may have in its control interface 208 one or more analog interfaces capable of receiving the analog output 205 from the secure digital content storage device 201. The control interfaces 208 of the external player device 207 may also re-digitize the received analog output 205 to generate a digital output 209 of its own for further distribution. For example, it may be useful to re-digitize the analog output 205 so that the redigitized output can be input to a computer for storage, playback, or other processing. However, the re-digitized version of the analog output 205 will not be an exact copy of the digital content stored in the digital content storage device 201 due to unavoidable information loss during the digital-to-analog and analog-to-digital conversion processes occurring at the decoder 203 and the control interface 208. In this way, the digital content of memory 202 itself is protected from any access or exact replication by an external device or unauthorized agent.

The secure digital content storage device 201 may further comprise a control interface 204 for controlling the processing of the digital content stored therein and transmission of the corresponding analog output 205 to the player device 207. For example, when the secure digital content storage device 201 and the player device 207, the control interface 204 of the secure digital content storage device 201 may initiate read out by the decoder 203 of the digital content stored in the memory 202 and cause the decoder 203 to decrypt and/or decode the digital content, generate the corresponding analog output 205, and transmit the analog output 205 to the player device 207. The transmission of the analog output 205 from the secure digital content storage device 201 to the player device 207 may be facilitated by a control communication channel 206 established between the control interface 204 of the storage device 201 and the control interface 208 of the player device 207. Upon receiving the analog output 205 from the secure digital content storage device 201, the control interface 208 of the player device 207 may generate a suitable audio/video signal 209, or re-digitize the analog output 205 for further distribution as described above. However, the player device 207 or any other external device interfacing to the secure digital content storage device 201 is physically prevented from accessing the digital content stored in the storage device 201. It can only access the analog counterpart output 205 from the secure digital content device 201. In this way, any unauthorized replication of or tampering with the digital content source stored in the memory 202 may be prevented.

In view of the foregoing embodiment, it can be envisioned that a secure digital content storage device may be implemented in a simple physical package of a single IC containing a large-capacity flash memory to which a decoder is directly coupled. Since the cost of flash memory is rapidly coming down while its capacity is continuously increasing, such device is an attractive technological as well as economical secure alternative to less secure conventional digital content storage media such as CD-ROMs, DVDs, or flash memory that provide a readily accessible digital output. The security of the digital content in such device is achieved by a simple physical approach, without having to rely on complex and costly encryption or other digital rights management technology.

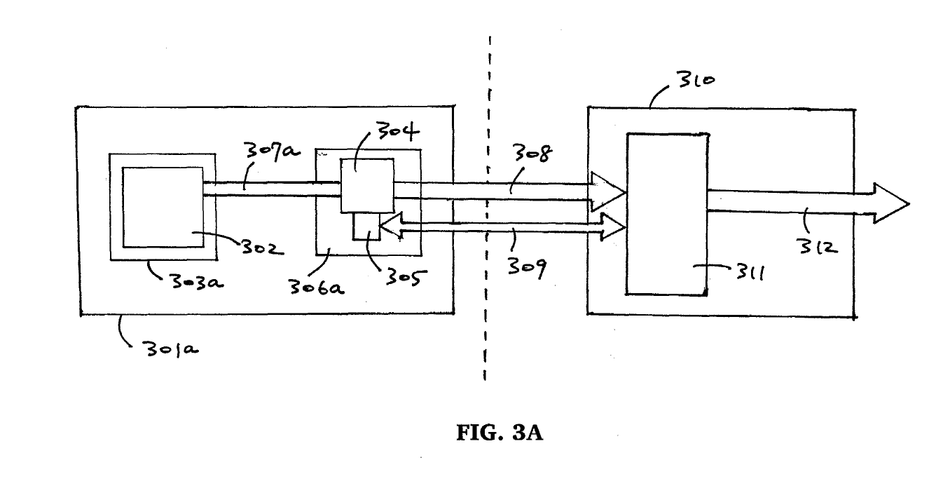

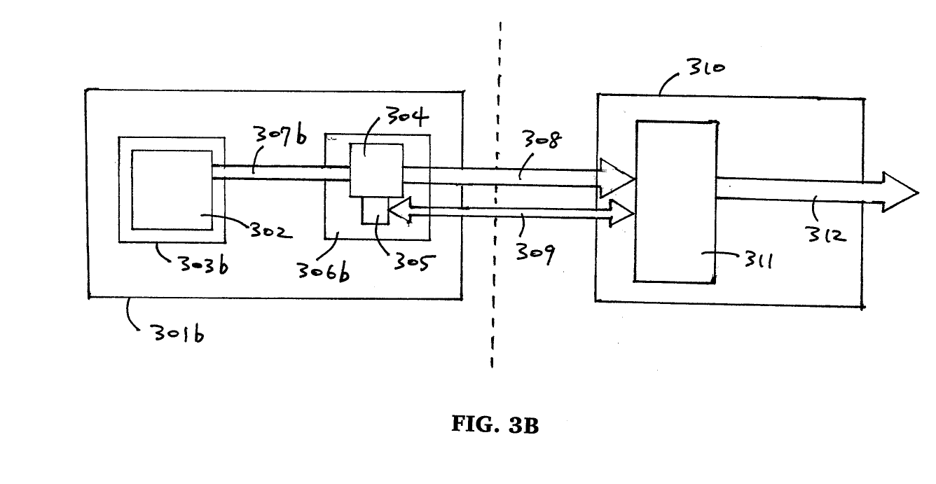

The schematic block diagrams shown in FIGS. 3A and 3B illustrate alternative embodiments of the present invention for a secure digital content storage device 301. In the secure digital content storage device 301, a memory 302 for storing digital content and a decoder 304 are coupled together by a secure connection 307. Although not shown in FIGS. 3A and 3B, in other alternative embodiments of the present invention, a secure digital content storage device may comprise multiple memories and decoders, where each memory is coupled to the corresponding decoder by a secure connection.

Unlike the embodiment shown in FIG. 2, the memory 302 and the decoder 304 in FIGS. 3A and 3B are not confined to the same single monolithic IC. In one possible example of the embodiment shown in FIG. 3A, the memory 302 and the decoder 304 may be located in different IC dies 303a and 306a in a single multi-die package 301a. In this example, the secure connection 307a coupling the memory 302 to the decoder 304 may comprise wiring encapsulated in a tamper-resistant housing or protective cover, which is designed to foil any attempt by an external device or agent to access the digital content stored in the memory 302 through the connection 307. For example, the secure connection 307 between the memory 302 and the decoder 304 may be formed by encasing the potentially accessible portions of the wiring with a synthetic resin (e.g., duroplast encapsulation).

In another example shown in FIG. 3B, the memory 302 and the decoder 304 may be located in different chip packages 303b and 306b on a multilayer PC board 301b. In this case, the secure connection 307b between the memory 302 and the decoder 304 may be established in an interior layer of the multilayer PC board 301b in such a way that the connection 307b is substantially physically hidden and thereby inaccessible from outside of the PC board. In this way, any external access to the digital content stored in the memory 302 may be prevented and the digital content may be accessed only by the decoder 304.

Like FIG. 2, FIGS. 3A and 3B also show how the secure digital content storage device 301a, b may interface with an external player device 310 without compromising the security of the stored digital content. Significantly, the only output of the secure digital content storage device 301a, b that the player device 310 or any other external device interfacing with the secure digital content storage device 301a, b can access is the analog output 308.

The secure digital content storage device 301 may further comprise a control interface 305 for controlling the processing of the digital content stored therein and transmission of the corresponding analog output 308 to the player device 310. When a connection is established between the secure digital content storage device 301 and the player device 310a,b the control interface 305 of the secure digital content storage device 301a, b may initiate read out of the digital content stored in the memory 302 by the decoder 304 and cause the decoder 304 to decrypt/decode the digital content, generate the corresponding analog output 308, and transmit the analog output 308 to the player device 310. The transmission of the analog output 308 from the secure digital content storage device 301a, b to the player device 310a, b may be facilitated by a control communication channel 309 established between the control interface 305 of the storage device 301a, b and a control interface 311 of the player device 310. Upon receiving the analog output 308 from the secure digital content storage device 301a, b, the control interface 311 of the player device 310 generates a suitable audio/video signal 312, or may re-digitize the analog output 308 for further distribution. As in the exemplary embodiment illustrated in FIG. 2, the player device 310 or any other external device interfacing the secure digital content storage device 301a, b is physically prevented from accessing the digital content stored in the storage device 301a, b. It can only access the analog counterpart 308 from the secure digital content device 301. Hence, unauthorized replication or tampering of the digital content source stored in the memory 302 may be prevented.

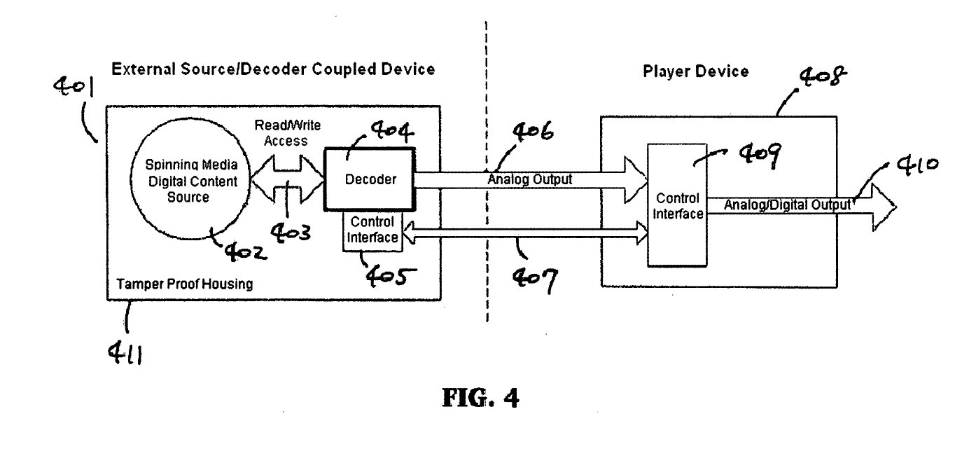

FIG. 4 is a schematic block diagram of yet another exemplary embodiment of the present invention for a secure digital content storage device 401. In the secure digital content storage device 401, a memory 402 for storing digital content and a decoder 404 coupled to the memory 402 via read/write access mechanism 403 are encased within a secure, preferably tamper-proof, enclosure or housing 411. The memory 402 may be any storage medium, such as a hard disk, a semiconductor memory, a memory card, a floppy disk, a Digital Versatile Disk-Read Only Memory (DVD-ROM), a Magneto-Optical (MO) disk, and/or a Compact Disk-Recordable (CD-R). Based on the type of storage medium used for the memory 402, a suitable decoder 404 and read/write access mechanism 403 are used in the secure digital content storage device 401. The decoder 404 may be an audio/video decoder, and is designed to access the digital content stored in the memory 402, decrypt and/or decode it, and generate the corresponding analog output 406 in a suitable format.

The secure enclosure or tamper-proof housing 411 is designed to prevent any physical access to the digital content stored in the memory 402 by an external device on unauthorized agent.

To strengthen the security of the enclosure or housing 411, it may comprise a mechanism for substantially destroying the digital content stored in the memory 402, if the housing 411 is breached and the memory 402 becomes exposed to external access and possible tampering. For example, the storage medium for the memory 402 may be made entirely or in part of a water-soluble polymer such as Polyvinyl Alcohol (PVA), which instantly dissolves when in contact with water (thus destroying the content of the storage medium). A water capsule may be incorporated into the secure enclosure 411 in such a way that when the enclosure 411 is breached, the water capsule releases the water to substantially destroy the digital content stored in the memory 402. As another example, the secure enclosure 411 may contain a two-part expandable foam with a corrosive additive. The additive is selected to be corrosive to the storage medium material for the memory 402. Any tampering with the enclosure 411 would cause the two parts to mix and trigger a foaming action. The expanding foam with the corrosive additive would subsequently destroy the digital content in the memory 402.

Like FIG. 2, FIG. 4 also shows how the secure digital content storage device 401 may interface with an external player device 408 without compromising the security of the stored digital content. Significantly, the only output of the secure digital content storage device 401 that the player device 408 or any other external device interfacing with the secure digital content storage device 401 can access is the analog output 406.

In yet another alternative embodiments of the present invention, the secure enclosure or tamper-proof housing described in connection with FIG. 4 may be used protect the memory and decoder of the embodiments shown in FIGS. 2, 3A and 3B so that the security of the digital content in the storage device can be further strengthened.

The secure digital content storage device 401 may further comprise a control interface 405 for controlling the processing of the digital content stored therein and transmission of the corresponding analog output 406 to the player device 408. When the physical and control interface is established between the secure digital content storage device 401 and the player device 408, the control interface 405 of the secure digital content storage device 401 may initiate read out of the digital content stored in the memory 402 by the decoder 404 via the read/write access mechanism 403 and cause the decoder 404 to decrypt/decode the digital content, generate the corresponding analog output 406, and transmit the analog output 406 to the player device 408. The transmission of the analog output 406 from the secure digital content storage device 401 to the player device 408 may be facilitated by a control communication channel 407 established between the control interface 405 of the storage device 401 and a control interface 409 of the player device 408. Upon receiving the analog output 406 from the secure digital content storage device 401, the control interface 409 of the player device 408 generates a suitable audio/video signal 410, or may re-digitize the analog output 406 for further distribution. As in the exemplary embodiment illustrated in FIG. 2, the player device 408 or any other external device interfacing the secure digital content storage device 401 is physically prevented from accessing the digital content stored in the storage device 401. It can only access the analog counterpart output 406 from the secure digital content device 401. Hence, unauthorized replication or tampering of the digital content stored in the memory 402 may be prevented.

Under the present invention, by protecting the connection between the two fundamental processes of data storage and decoding (e.g., by way of direct coupling between a memory and a decoder within a single monolithic IC structure as shown in FIG. 2, by providing a secure connection between a memory and a decoder as shown in FIG. 3, or by encasing the coupled memory-decoder within a tamper-proof housing as shown in FIG. 4), external access to the stored digital content is restricted and thereby unauthorized replication or tampering of the digital content source can be prevented. By permitting only the analog counterpart to the digital content to be transmitted to an external device, the present invention discourages unauthorized replication of the original digital data.

While this invention has been described in conjunction with exemplary embodiments detailed above and illustrated in the drawings, it is evident that many alternatives, modifications and variations will be apparent to those skilled in the art. Accordingly, the exemplary embodiments of the invention, as set forth above, are intended to be illustrative, not limiting, and the spirit and scope of the present invention is to be construed broadly and limited only by the appended claims, and not by the foregoing specification.

What is claimed is:

1. A secure digital content storage device, comprising:
a memory for storing digital data; and
a decoder, directly coupled to the memory, for accessing the digital data stored in the memory and generating an analog output based on the accessed digital data, wherein the memory and decoder are coupled within a single integrated circuit so that the digital data stored in the memory is substantially inaccessible except by the decoder.

2. The secure digital content storage device of claim 1, further comprising a control circuit for controlling the processing of the digital data within the single integrated circuit.

3. The secure digital content storage device of claim 1, further comprising an analog-to-digital converter for re-digitizing the analog output.

4. A secure digital content storage device, comprising:
a memory for storing digital data;
a decoder for accessing the digital data stored in the memory and generating analog output based on the accessed digital data; and
a secure connection for coupling the memory to the decoder so that the digital data stored in the memory is substantially inaccessible except by the decoder.

5. The secure digital content storage device of claim 4, wherein the memory and the decoder are located on different integrated circuit dies.

6. The secure digital content storage device of claim 5, wherein the secure connection comprises wiring encapsulated in a tamper-resistant housing.

7. The secure digital content storage device of claim 4, wherein the memory and the decoder are located in different chip packages on a multilayer PC board.

8. The secure digital content storage device of claim 7, wherein the secure connection between the memory and the decoder is formed in an interior layer of the multilayer PC board so that the memory output is substantially inaccessible

9. The secure digital content storage device of claim 4, further comprising a control circuit for controlling the processing of the digital data.

10. The secure digital content storage device of claim 4, further comprising an analog-to-digital converter for re-digitizing the analog output.

11. A secure digital content storage device, comprising:
a memory for storing digital data;
a decoder, coupled to the memory, for accessing the digital data stored in the memory and generating analog output based on the accessed digital data; and
a secure enclosure for protecting the memory and decoder from external tampering, so that the digital data stored in the memory is substantially inaccessible except by the decoder.

12. The secure digital content storage device of claim 11, further comprising a control circuit for controlling the processing of the digital data within the secure enclosure.

13. The secure digital content storage device of claim 11, wherein the secure enclosure is a tamper-proof housing enclosing the memory and decoder.

14. The secure digital content storage device of claim 11, wherein the memory is a storage medium coupled to the decoder via a read/write access.

15. The secure digital content storage device of claim 14, wherein the storage medium is DVD, CD-R, magneto-optical disc, floppy disk, memory card, hard disk, or semiconductor memory.

16. The secure digital content storage device of claim 11, wherein the secure enclosure comprises a mechanism for substantially destroying the digital data stored in the memory when the memory becomes exposed to the external tampering.

17. The secure digital content storage device of claim 11, further comprising an analog-to-digital converter for re-digitizing the analog output.

18. The secure digital content storage device of claim 11, wherein the memory and decoder are coupled within a single integrated circuit.

19. The secure digital content storage device of claim 11, wherein the memory and the decoder are located on different integrated circuit dies.

20. The secure digital content storage device of claim 19, wherein the memory and the decoder are coupled by wiring encapsulated in a tamper-resistant housing.

21. The secure digital content storage device of claim 11, wherein the memory and the decoder are located in different chip packages on a multilayer PC board.

22. The secure digital content storage device of claim 21, wherein the memory and the decoder are coupled by a connection formed in an interior layer of the multilayer PC board.
